(19) United States
(12) Patent Application Publication
(10) Pub. No.: US 2014/0265835 A1
(43) Pub. Date: Sep. 18, 2014

(54) THREE-WAY LED BULB DRIVER

(71) Applicant: Switch Bulb Company, Inc., San Jose, CA (US)

(72) Inventor: Stanley CANTER, Hermosa Beach, CA (US)

(21) Appl. No.: 13/831,484

(22) Filed: Mar. 14, 2013

(51) Int. Cl. H05B 33/08

(52) U.S. Cl. CPC H05B 33/0809; H05B 33/0845
USPC 315/53; 315/51

(57) ABSTRACT

An LED bulb is described. The LED bulb comprises a shell, a plurality of LEDs within the shell, a driver circuit connected to the plurality of LEDs, and a base connected to the shell. The driver circuit comprises a first input to receive AC voltage, a second input to receive AC voltage, a neutral input, a power supply circuit connected to the plurality of LEDs, and a brightness control circuit. The brightness control circuit is connected to the first input, the second input, and the power supply circuit. The brightness control circuit is configured to output a modified AC voltage to the power supply circuit. The modified AC voltage is created by blocking a portion of a cycle of AC received by the first or second input. The blocked portion is based on whether the first input, the second input, or the first and second inputs are both hot.

### BACKGROUND

1. Field

The present disclosure relates generally to drivers for light emitting diode (LED) bulbs, and more specifically to drivers for LED bulbs that enable the LED bulb to emit light at different levels of brightness.

2. Description of Related Art

Conventional incandescent light bulbs that have three lighting levels (“three-way light bulbs”) include two filaments; in the minimum illumination setting a low wattage filament is energized, in the medium illumination case a medium wattage filament is energized, in the high illumination case both filaments are energized. The illumination setting is selected by energizing a first input connected to the low wattage filament, energizing a second input connected to the medium filament, or energizing both the first and second inputs.

The conventional incandescent three-way light bulb has three electrical contacts, hot1, hot2 and neutral. A switch, contained in the lamp base, connects terminal hot1 to mains power (e.g., a 120 VAC 60 Hz signal in the U.S.) in the low power case, connects hot2 to mains power in the medium power case, and connects both hot1 and hot2 to mains power in the high power case. Terminal hot1 is connected to the low wattage filament and terminal hot2 is connected to the medium wattage filament. Thus either or both filaments may be selected to provide three levels of illumination.

One method for reproducing the same functionality of the incandescent three-way light bulb in an LED bulb is to have two sets of LEDs with each set having its own driver connected to a different hot input. However, this requires having two driver circuits, which increases costs and increases space requirements that are limited when implementing LED bulbs in typical form factors of standard light bulbs. Therefore, it is desirable to connect multiple hot inputs to a single driver circuit. However, this requires the driver circuit to sense which of two terminals are energized and set the supply current of the LEDs accordingly. This could be done by inserting a component in series with each input and sensing the voltage drop across this series component. While this technique may work in principle, it would introduce power losses in the series component. Additionally, this technique requires many additional parts to amplify and detect the voltage. These parts increase the cost of the LED bulb, and are therefore undesirable.

### BRIEF SUMMARY

A light emitting diode (LED) bulb is described. The LED bulb comprises a shell, a plurality of LEDs within the shell, a driver circuit connected to the plurality of LEDs, and a base connected to the shell. The driver circuit comprises a first input configured to receive alternating current (AC) voltage, a second input configured to receive AC voltage, a neutral input, a power supply circuit connected to the plurality of LEDs, and a brightness control circuit connected to the first input, the second input, and the power supply circuit. The brightness control circuit is configured to output a modified AC voltage to the power supply circuit. The modified AC voltage is created by blocking a blocked portion of a cycle of AC voltage cycle received by the first input or the second input. The blocked portion is based on whether the first input is hot, the second input is hot, or the first and second inputs are both hot.

An LED bulb driver circuit configured to operate an LED bulb is also described.

### DESCRIPTION OF THE FIGURES

FIG. 1 depicts an exemplary LED bulb that may be used with the exemplary driver circuit employing a brightness control circuit.

FIG. 2 depicts a functional block schematic of an exemplary driver circuit employing a brightness control circuit.

FIG. 3 depicts an exemplary circuit topology for the brightness control circuit.

FIG. 4 depicts three graphs showing the output of the brightness control circuit.

### DETAILED DESCRIPTION

The following description is presented to enable a person of ordinary skill in the art to make and use the various embodiments. Descriptions of specific devices, techniques, and applications are provided only as examples. Various modifications to the examples described herein will be readily apparent to those of ordinary skill in the art, and the general principles defined herein may be applied to other examples and applications without departing from the spirit and scope of the various embodiments. Thus, the various embodiments are not intended to be limited to the examples described herein and shown, but are to be accorded the scope consistent with the claims.

An exemplary LED driver circuit that can drive one or more LEDs at three different brightness levels by driving the LEDs at three different currents is described below. The driver circuit may use low cost parts that are compact (e.g., surface mountable). Accordingly, the driver circuit is suitable for use in an LED bulb.

FIG. 1 depicts an exemplary LED bulb 100. The LED bulb maybe liquid-filled. LED bulb 100 includes a base 110 and a shell 101 encasing the various components of LED bulb 100. The shell 101 is attached to the base 110 forming an enclosed volume. An array of LEDs 103 are mounted to support structures 107 and are disposed within the enclosed volume. The enclosed volume may be filled with a thermally conductive liquid 111.

For convenience, all examples provided in the present disclosure describe and show LED bulb 100 being a standard A-type form factor bulb. However, as mentioned above, it should be appreciated that the present disclosure may be applied to LED bulbs having any shape, such as a tubular bulb, globe-shaped bulb, or the like.

Shell 101 may be made from any transparent or translucent material such as plastic, glass, polycarbonate, or the like. The shell 101 may be clear or frosted to disperse light produced by the LEDs. Shell 101 has a geometric center and an apex located at the top of the LED bulb 100 as it is drawn in FIG. 1.

As noted above, light bulbs typically conform to a standard form factor, which allows bulb interchangeability between different lighting fixtures and appliances. Accordingly, in the present exemplary embodiment, LED bulb 100 includes connector base 115 for connecting the bulb to a lighting fixture. In one example, connector base 115 may be a conventional light bulb base having threads 117 for insertion into a conventional light socket. However, as noted above, it should be appreciated that connector base 115 may be any type of connector for mounting LED bulb 100 or coupling to a power source. For example, connector base may provide mounting via a screw-in base, a dual-prong connector, a standard two- or three-prong wall outlet plug, bayonet base, Edison Screw base, single pin base, multiple pin base, recessed base, flanged base, grooved base, side base, or the like.

In some embodiments, LED bulb 100 may use 6 W or more of electrical power to produce light equivalent to a 40 W incandescent bulb. In some embodiments, LED bulb 100 may use 18 W or more to produce light equivalent to or greater than a 75 W incandescent bulb. Depending on the efficiency of the LED bulb 100, between 4 W and 16 W of heat energy may be produced when the LED bulb 100 is illuminated.

The LED bulb 100 includes several components for dissipating the heat generated by LEDs 103. For example, as shown in FIG. 1, LED bulb 100 includes one or more support structures 107 for holding LEDs 103. Support structures 107 may be made of any thermally conductive material, such as aluminum, copper, brass, magnesium, zinc, or the like. In some embodiments, the support structures are made of a composite laminate material. Since support structures 107 are formed of a thermally conductive material, heat generated by LEDs 103 may be conductively transferred to support structures 107 and passed to other component of the LED bulb 100 and the surrounding environment. Thus, support structures 107 may act as a heat-sink or heat-spreader for LEDs 103.

Support structures 107 are attached to bulb base 110 allowing the heat generated by LEDs 103 to be conducted to other portions of LED bulb 100. Support structures 107 and bulb base 110 may be formed as one piece or multiple pieces. The bulb base 110 may also be made of a thermally conductive material and attached to support structures 107 so that heat generated by LED 103 is conducted into the bulb base 110 in an efficient manner. Bulb base 110 is also attached to shell 101. Bulb base 110 can also thermally conduct with shell 101.

Bulb base 110 also includes one or more components that provide the structural features for mounting bulb shell 101 and support structure 107. Components of the bulb base 110 include, for example, sealing gaskets, flanges, rings, adaptors, or the like. Bulb base 110 also includes a connector base 115 for connecting the bulb to a power source or lighting fixture. Bulb base 110 can also include one or more die-cast parts.

LED bulb 100 may be filled with thermally conductive liquid 111 for transferring heat generated by LEDs 103 to shell 101. The thermally conductive liquid 111 fills the enclosed volume defined between shell 101 and bulb base 110, allowing the thermally conductive liquid 111 to thermally conduct with both the shell 101 and the bulb base 110. In some embodiments, thermally conductive liquid 111 is in direct contact with LEDs 103.

Thermally conductive liquid 111 may be any thermally conductive liquid, mineral oil, silicone oil, glycols (PAGs), fluorocarbons, or other material capable of flowing. It may be desirable to have the liquid chosen be a non-corrosive dielectric. Selecting such a liquid can reduce the likelihood that the liquid will cause electrical shorts and reduce damage done to the components of LED bulb 100.

LED bulb 100 may include a mechanism to allow for thermal expansion of thermally conductive liquid 111 contained in the LED bulb 100. In the present exemplary embodiment, the mechanism is a bladder 120. The outside surface of the bladder 120 is in contact with the thermally conductive liquid 111.

The LED bulb 100 further contains the driver circuit. Connector base 115 may include two hot contacts and a neutral contact. In exemplary LED bulb 100, the driver circuit may be driver circuit 200 discussed below with respect to FIG. 2 and is substantially contained within connector base 115. In this context, substantially contained means that the majority of the driver circuit is within connector base 115, but portions of driver circuit components may be protruding from connector base 115. For example, portions of the driver circuit may protrude above connector base 115 into bulb base 110 or shell 101. Similarly, the driver circuit may be substantially contained within bulb base 110.

The driver circuit may be integrated onto a single printed circuit board, which fits within the LED bulb 100. In one case, the driver circuit is integrated on a single printed circuit board and fits substantially within the bulb base or connector base of the LED bulb 100.

FIG. 2 depicts a functional level diagram of exemplary driver circuit 200. Driver circuit 200 may be used in an LED bulb to power one or more LEDs 216. Driver circuit 200 takes as input an input line voltage (e.g., 120 VAC, 60 Hz in the U.S.) from a three-way switch connected to input 202, which includes hot input 202a, hot input 202b, and neutral input 202c. At output 204, driver circuit 200 outputs a current suitable for powering LEDs 216, which are connected to output 204. The three-way switch will energize hot input 202a only, hot input 202b only, or both hot inputs 202a and 202b at the same time. The LEDs 216 will not be illuminated when the three-way switch does not energize any of hot inputs 202a and 202b.

As will be described in more detail below, driver circuit 200 includes brightness control circuit 206, input protection circuit 208, input filter circuit 210, switched mode power supply (SMPS) circuit 212, and peripheral circuit 214. Not all elements of driver circuit 200 are required. For example, peripheral circuit 214 is optional and may be, for example, a thermal protection circuit or a power factor control circuit. Brightness control circuit 206 is configured to enable the LED bulb to produce different levels of light output depending on whether hot input 202a, hot input 202b, or both hot inputs 202a and 202b are energized. Input protection circuit 208 is configured to protect driver circuit 200 and LEDs 216 from damage due to voltage spikes in the input line voltage or to prevent electrical shorts in the LED bulb from damaging the surrounding environment. Input protection circuit 208 is configured to also limit the input current when a switched voltage is first applied to input 202. Input filter circuit 210 is configured to condition the input line voltage for use with SMPS circuit 212, and to prevent noise generated by SMPS circuit 212 from reaching input 202 and affecting other devices connected to the input line voltage. SMPS circuit 212 is configured to convert the input line voltage to a current that is suitable for driving one or more LEDs 216. Peripheral circuit 214 may have various functions depending on the purpose of the circuit. For example, peripheral circuit 214 may be configured to reduce or eliminate the current being supplied to LEDs 216 in the event that drive circuit 200, LEDs 216, or some other part of the LED bulb reaches a threshold temperature. As another example, peripheral circuit 214 may be configured to adjust the current that SMPS circuit 212 supplies to LEDs 216.

While FIG. 2 depicts a particular configuration of blocks, it should be understood that the blocks may be configured differently or some blocks may be omitted without deviating from embodiments of the present invention. For example, input protection circuit 208 may be located between brightness control circuit 206 and input 202. Brightness control circuit 206 is described in detail below. The other blocks of driver circuit 200 may be implemented with various circuit architectures. One such example is described in U.S. Pat. No. 8,188,671, entitled “Power factor control for an LED bulb driver circuit,” filed Jun. 7, 2011, which is herein incorporated by reference in its entirety.

Brightness control circuit 206 enables LEDs 216 to operate at different levels of brightness by blocking a portion of an alternating current (AC) voltage that is applied to hot input 202a or input 202b. The size of the portion of the AC voltage that is blocked determines the brightness of LEDs 216. For example, if about half of the AC voltage is blocked and the rest of driver circuit 200 is configured to supply a current to LEDs 216 proportional to the size of the unblocked portion of the AC cycle, then LEDs 216 will output less light than if only a quarter of the AC voltage is blocked. The size of the portion of the AC voltage that is blocked is determined based on whether hot input 202a, hot input 202b, or both hot inputs 202a and 202b are hot.

For example, brightness control circuit 206 may be configured to: block two-thirds (⅔) of an AC voltage that is input on hot input 202a when hot input 202b is not energized; block one-third (⅓) of an AC voltage that is input on hot input 202b when hot input 202a is not energized; or block little to none of an AC voltage that is input into hot input 202b when hot inputs 202a and 202b are energized at the same time. In this configuration, the LEDs would output: the least amount of light when only hot input 202a is energized; the most amount of light when both hot input 202a and hot input 202b are energized; and a level of light in between the most and least amounts when only hot input 202b is energized.

FIG. 4 depicts graphs 402, 404, and 406 that show an AC voltage with various portions of the AC voltage being blocked. Graph 402 depicts an AC voltage (represented by the solid line) with little to no blocking. Graph 404 depicts an AC voltage (represented by the solid line) where the first third of each cycle (portion 414) of the AC voltage is being blocked. Graph 406 depicts an AC voltage (represented by the solid line) where the first two-thirds of each cycle (portion 416) of the AC voltage is being blocked.

Brightness control circuit 206 may be configured so that the size of the blocked portion (e.g., zero, one-quarter, one-third, two-thirds, etc.) of the AC voltage is dependent on a time constant of the brightness control circuit that changes depending on whether only hot input 202a, only hot input 202b, or both hot inputs 202a and 202b are energized. For example: when only hot input 202a is energized, then a time constant for brightness control circuit 206 may have a relatively slow constant that blocks two-thirds of the beginning portion of each cycle of the AC voltage on hot input 202a before allowing the AC voltage to pass (see, e.g., graph 406 of FIG. 4); when only hot input 202b is energized, then a time constant for brightness control circuit 206 may have a relatively faster time constant (as compared to the time constant when only hot input 202a is energized) that blocks the first third of each cycle of the AC voltage on hot input 202a before allowing the AC voltage to pass (see, e.g., graph 404 of FIG. 4); and when both hot inputs 202a and 202b are energized, then the time constant for brightness control circuit 206 may be fast enough that very little, if any, of each cycle of the AC voltage is blocked (see, e.g., graph 402 of FIG. 4).

An exemplary circuit topology for brightness control circuit 200 is depicted in FIG. 3, as circuit 300. When only hot input 202 is energized, TRIAC 302 will block an AC voltage received on hot input 202a until DIAC 304 fires TRIAC 302. A TRIAC is a device that can conduct current in either direction between two terminals after being triggered or turned on by a current pulse at a third terminal. After being triggered, the TRIAC 302 continues to conduct current between the first and second terminal until that current falls below some threshold value, which is called the holding current. Thus, after DIAC 304 fires TRIAC 302, TRIAC 302 will continue to conduct the AC voltage at hot input 202a until the current drawn through TRIAC 302 drops below the holding current of TRIAC 302, which will occur when each cycle of the AC voltage signal restarts at zero.

The amount of time before DIAC 304 fires TRIAC 302 is determined based on the time constant set by resistor 308 and capacitor 306. The time constant is proportional to the value of resistor 308 multiplied by the value of capacitor 306. As the time constant increases (due to larger values of either resistor 308 or capacitor 306), it takes longer for DIAC 304 to fire TRIAC 302. The portion of an AC cycle that is blocked by TRIAC 302 expressed in terms of the phase angle when TRIAC 302 is fired is called the “firing angle.” For example, if TRIAC 302 blocks the first one-third of each AC cycle, then TRIAC 302 has a firing angle of 60 degrees (see, e.g., graph 404 of FIG. 4). If TRIAC 302 blocks the first two-thirds of each AC cycle, then TRIAC 302 has a firing angle of 120 degrees (see, e.g., graph 406 of FIG. 4). Accordingly, the time constant may be set to fire TRIAC 302 at a desired firing angle by selecting appropriate values for resistor 308 and/or capacitor 306. Thus, the output 324 of circuit 300 is based on the values of resistor 308 and/or capacitor 306.

Circuit 300 also includes TRIAC 312, DIAC 314, resistor 318, and capacitor 316, which operate in a similar manner as discussed above with respect to TRIAC 302, DIAC 304, resistor 308, and capacitor 306. However, TRIAC 312 is only fired when hot input 202b is energized. If hot input 202a is not energized, then the time constant (and the firing angle) are set by selecting values for resistor 318 and capacitor 316. For example, resistor 318 and capacitor 316 may be selected to produce a time constant that is relatively shorter than the time constant produced by resistor 308 and capacitor 306. A shorter time constant will produce a smaller firing angle, which will block less of the AC voltage and allow the LEDs to output more light (i.e., the LEDs will be brighter).

When both hot input 202a and hot input 202b are energized, TRIAC 312 will fire based on the time constant of capacitor 316 and the resistance of resistor 308 in parallel with resistor 310. Because resistors in parallel have a resistance smaller than either of the two resistors alone, the time constant of this combination will be faster than the time constant from resistor 318 with capacitor 316, which is produced when only hot input 202b is energized. Accordingly, the faster time constant means that TRIAC 312 is fired at an even smaller firing angle, which allows for more of the AC voltage through TRIAC 312 and for the LEDs to operate at an even brighter level.

Although a feature may appear to be described in connection with a particular embodiment, one skilled in the art would recognize that various features of the described embodiments may be combined. Moreover, aspects described in connection with an embodiment may stand alone.

What is claimed is:

1. A light emitting diode (LED) bulb comprising:
a shell;
a plurality of LEDs within the shell;
a driver circuit connected to the plurality of LEDs, the driver circuit comprising:
a first input configured to receive alternating current (AC) voltage;
a second input configured to receive AC voltage;
a neutral input;
a power supply circuit connected to the plurality of LEDs;
a brightness control circuit connected to the first input, the second input, and the power supply circuit; and
wherein the brightness control circuit is configured to output a modified AC voltage to the power supply circuit, wherein the modified AC voltage is created by blocking a blocked portion of a cycle of AC voltage cycle received by the first input or the second input, and
wherein the blocked portion is based on whether the first input is hot, the second input is hot, or the first and second inputs are both hot; and
a base connected to the shell.

2. The LED bulb of claim 1, wherein the driver circuit substantially fits within the base.

3. The LED bulb of claim 1, wherein the driver circuit completely fits within the base.

4. The LED bulb of claim 2, wherein the blocked portion is based on a time constant of the brightness control circuit.

5. The LED bulb of claim 4, wherein the time constant of the brightness control circuit is dependent on which of the first input and second input is hot.

6. The LED bulb of claim 4, wherein the time constant is based on a resistor and a capacitor.

7. The LED bulb of claim 2, wherein the brightness control circuit includes a first TRIAC configured to fire at a first angle based on a first time constant of the brightness control circuit.

8. The LED bulb of claim 7, wherein the first time constant is based on a first resistor and a first capacitor connected in series.

9. The LED bulb of claim 7, wherein the brightness control circuit includes a second TRIAC configured to fire at a second angle based on a second time constant of the brightness control circuit, wherein the first angle is larger than the second angle.

10. The LED bulb of claim 9, wherein the second time constant is based on a second resistor and a second capacitor connected in series.

11. The LED bulb of claim 2, wherein a first TRIAC is configured to fire at a first angle or a second angle based on a first time constant or a second time constant, respectively, of the brightness control circuit, and wherein the first angle is larger than the second angle.

12. The LED bulb of claim 1, wherein the first time constant is based on a first resistor and a first capacitor connected in series, and wherein the second time constant is based on the first resistor, a second resistor, and the first capacitor.

13. The LED bulb of claim 1, the driver circuit further comprising:
a switch mode power supply (SMPS) circuit connected to the brightness control circuit, wherein the SMPS circuit is configured to supply a current to a plurality of LEDs, wherein the current is proportional to a size of the blocked portion of the AC voltage cycle.

14. The LED bulb of claim 13, the driver circuit further comprising:
an input filter circuit, the input filter circuit connected between the SMPS circuit and the brightness control circuit.

15. A light emitting diode (LED) bulb driver circuit configured to operate an LED bulb at a plurality of brightness levels, the driver circuit comprising:
a first input configured to receive alternating current (AC) voltage;
a second input configured to receive AC voltage;
a neutral input;
a power supply circuit connected to a plurality of LEDs;
a brightness control circuit connected to the first input, the second input, and the power supply circuit; and
wherein the brightness control circuit is configured to output a modified AC voltage to the power supply circuit, wherein the modified AC voltage is created by blocking a blocked portion of a cycle of AC voltage cycle received by the first input or the second input, and
wherein the blocked portion is based on whether the first input is hot, the second input is hot, or the first and second inputs are both hot.

16. The driver circuit of claim 15, wherein the blocked portion is based on a time constant of the brightness control circuit.

17. The driver circuit of claim 16, wherein the time constant of the brightness control circuit is dependent on which of the first input and second input is hot.

18. The driver circuit of claim 16, wherein the time constant is based on a resistor and a capacitor.

19. The driver circuit of claim 15, wherein the brightness control circuit includes a first TRIAC configured to fire at a first angle based on a first time constant of the brightness control circuit.

20. The driver circuit of claim 19, wherein the first time constant is based on a first resistor and a first capacitor connected in series.

21. The driver circuit of claim 19, wherein the brightness control circuit includes a second TRIAC configured to fire at a second angle based on a second time constant of the brightness control circuit, wherein the first angle is larger than the second angle.

22. The driver circuit of claim 21, wherein the second time constant is based on a second resistor and a second capacitor connected in series.

23. The driver circuit of claim 15, wherein a first TRIAC is configured to fire at a first angle or a second angle based on a first time constant or a second time constant, respectively, of the brightness control circuit, and wherein the first angle is larger than the second angle.

24. The driver circuit of claim 15, wherein the first time constant is based on a first resistor and a first capacitor connected in series, and wherein the second time constant is based on the first resistor, a second resistor, and the first capacitor.

25. The driver circuit of claim 15 further comprising:
a switch mode power supply (SMPS) circuit connected to the brightness control circuit, wherein the SMPS circuit is configured to supply a current to a plurality of LEDs, wherein the current is proportional to a size of the blocked portion of the AC voltage cycle.

26. The driver circuit of claim 25, further comprising:
an input filter circuit, the input filter circuit connected between the SMPS circuit and the brightness control circuit.
